(19) United States
(12) Patent Application Publication
(10) Pub. No.: US 2012/0097829 A1
(43) Pub. Date: Apr. 26, 2012

(54) EARTHQUAKE-RESISTING SUPPORT DEVICE FOR OBJECT

(75) Inventor: Ryozo Yoneda, Tokyo (JP)

(73) Assignees: ANTISISMO CO., LTD., Tokyo (JP); Ryozo Yoneda, Tokyo (JP)

(21) Appl. No.: 13/277,460

(22) Filed: Oct. 20, 2011

(30) Foreign Application Priority Data
Oct. 26, 2010 (JP) 2010-239280

(51) Int. Cl. F16M 13/00; F16M 11/00

(52) U.S. Cl. 248/636

(57) ABSTRACT

A sphere is attached to a holding table receiving a load of an object. A friction contact surface taking the shape of an internal surface of a sphere which comes in contact with the sphere is formed on the holding table. The friction contact surface is formed between a circular small diameter edge and a circular large diameter edge, the circular small diameter edge having a certain radius from a vertical line passing through a center of the sphere, and the circular large diameter edge setting, as a maximum radius, a radius along a horizontal surface passing through a center of the sphere. With increasing an acceleration of the earthquake, a state in which the sphere is horizontally moved integrally with the holding table is changed into a state in which the sphere comes in sliding contact with the friction contact surface to spin in the holding table.

### CROSS-REFERENCE TO RELATED APPLICATIONS

The present application claims priority from Japanese Patent Application No. 2010-239280 filed on Oct. 26, 2010, the content of which is hereby incorporated by reference into this application.

### TECHNICAL FIELD OF THE INVENTION

The present invention relates to an earthquake- resisting support device for object configured to stably support an object such as various apparatuses and instruments disposed on a base at the time of earthquake.

### BACKGROUND OF THE INVENTION

As an earthquake-resisting support device configured to stably support an object such as computer and precision apparatus disposed in a building at the time of earthquake, there is a configuration in which a sphere formed of steel is disposed between the object and a base surface. In an earthquake-resisting support device using the sphere, it is attached to the object through a link mechanism or a support frame.

For example, Patent Document 1 (Japanese Patent Application Laid-Open Publication No. 10-205577) discloses a seismically-isolating device having a sphere disposed between plate-shaped lower and upper surface members and a link mechanism for coupling the sphere with the lower surface member and the sphere with the upper surface member, and serving to rock the sphere and to deform the link mechanism at the time of earthquake. Moreover, Patent Document 2 (Japanese Patent No. 3409611) discloses an earthquake-resisting support device which causes a sphere to come in contact with a circular marginal part, that is, an edge provided for a support frame and accommodates the sphere in the support frame. Furthermore, Patent Document 3 (Japanese Patent Application Laid-Open Publication No. 2001-227583) discloses an earthquake-resisting support device in which a cone-shaped housing hole is formed on a support frame and a sphere is caused to come in line contact with a cone-shaped internal surface.

### SUMMARY OF THE INVENTION

In the earthquake-resisting support device or the seismically-isolating device using the sphere, there is an advantage that it is possible to prevent a vibration from being transmitted to the object due to a rotation of the sphere when an earthquake having a small exciting force occurs if the sphere is disposed directly between an object-side flat contact surface and a flat base surface. On the other hand, there is a problem in that the object goes out of control when an earthquake having a great exciting force occurs. For this reason, by coupling the sphere with the lower surface member and the sphere with the upper surface member through the link mechanism as described in Patent Document 1, it is possible to prevent a vibration on the base side from being transmitted to the object when the exciting force is increased to some degree at the time of earthquake. However, since the link mechanism is provided between the object and the base surface, there is a problem in that the earthquake-resisting support device is complicated in structure.

On the other hand, as described in Patent Documents 2 and 3, it was found that an acceleration to be transmitted to an object, that is, a response acceleration can be prevented from being increased when the exciting force of the earthquake is increased in the earthquake-resisting support device for causing the sphere to come in contact with the circular edge portion, that is, the edge provided on the support frame or the earthquake-resisting support device in which the cone-shaped housing hole is formed on the support frame and the sphere is caused to come in line contact with the cone-shaped internal surface.

However, in the case in which the sphere is caused to come in contact with the edge of the support frame or to come in line contact with the support frame, there is a limit on the reduction in the acceleration to be transmitted to the object, that is, the response acceleration. For this reason, an earthquake-resisting support cannot be carried out for an earthquake having a high seismic intensity such as the Great Hanshin-Awaji Earthquake and it was impossible to prevent the object from falling down.

An object of the present invention is to prevent an object from falling down to enhance the reliability of an earthquake-resisting support device even if an earthquake having a great exciting force occurs.

An earthquake-resisting support device for object according to the present invention stably supports an object disposed on a base at the time of earthquake, the earthquake-resisting support device for object comprising: a metallic holding table attached to one of the object and the base; and a sphere formed of steel, and attached into the holding table and protruded from an opening surface of the holding table to come in contact with a support surface provided to the other of the object and the base, wherein a friction contact surface taking a shape of an internal surface of a sphere which comes in contact with the sphere is formed in the holding table between a circular small diameter edge and a circular large diameter edge, the circular small diameter edge having a certain radius from a vertical line passing through a center of the sphere and serving to define a concave portion which a surface inside portion of the sphere enters, and the circular large diameter edge setting, as a maximum radius, a radius along a horizontal surface passing through a center of the sphere, a static friction coefficient of the friction contact surface and the sphere is set to be smaller than a static friction coefficient of the sphere and the support surface, and with increasing an acceleration of the earthquake, a state in which the sphere is horizontally moved integrally with the holding table is changed into a state in which the sphere comes in sliding contact with the friction contact surface to spin in the holding table, thereby suppressing a transmission of a vibration to the object from the base.

In the earthquake-resisting support device for object according to the present invention, a small diameter edge angle formed by a virtual conical surface having an apex located at a center of the sphere and passing through the small diameter edge is greater than a static friction angle of the sphere and the holding table. In the earthquake-resisting support device for object according to the present invention, a large diameter edge angle formed by a virtual conical surface having an apex located at a center of the sphere and passing through the large diameter edge and a vertical axis passing through the center of the sphere is within the range from 90 degrees to 45 degrees. In the earthquake-resisting support device for object according to the present invention, a chromium plating coated layer is provided on the friction contact surface and a friction coefficient “μ” between the friction contact surface and the sphere is set to be approximately 0.16 to 0.17. In the earthquake-resisting support device for object according to the present invention, a coated layer formed of a fluororesin is provided on the friction contact surface and a friction coefficient “μ” between the friction contact surface and the sphere is set to be approximately 0.11. In the earthquake-resisting support device for object according to the present invention, at least three holding tables are attached to a support plate for supporting the object, and spheres attached to the respective holding tables are disposed on a support surface of a base plate provided on the base.

In the earthquake-resisting support device according to the present invention, the friction contact surface is formed on the holding table accommodating the sphere. By this means, with increasing an acceleration of the earthquake, a state in which the sphere is horizontally moved integrally with the holding table is caused to be changed into a state in which the sphere comes in sliding contact with the friction contact surface to spin while coming in rolling contact with the support surface. Therefore, it is possible to prevent the object from falling down and going out of control even if an earthquake having a great exciting force occurs.

### BRIEF DESCRIPTIONS OF THE DRAWINGS

FIG. 1A is a plan view showing an earthquake-resisting support device for object according to one embodiment of the present invention;

FIG. 1B is a front view of FIG. 1A;

FIG. 2 is an enlarged cross-sectional view of part of FIGS. 1A and 1B;

FIGS. 3A to 3E are schematic views each showing an operation to be performed at the time of earthquake by the earthquake-resisting support device shown in FIG. 2;

FIG. 4 is an earthquake-resisting characteristic diagram at the time of earthquake in the earthquake-resisting support device shown in FIG. 2;

FIGS. 5A to 5E are comparison views each showing a friction coefficient of a contact portion of a sphere and a holding table obtained by changing the shape of the holding table; and

FIGS. 6A and 6B are earthquake-resisting characteristic diagrams each indicative of a result obtained by measuring a comparison between an input acceleration and a response acceleration by changing a friction coefficient of a friction contact surface in the earthquake-resisting support device according to the present invention.

### DESCRIPTIONS OF THE PREFERRED EMBODIMENTS

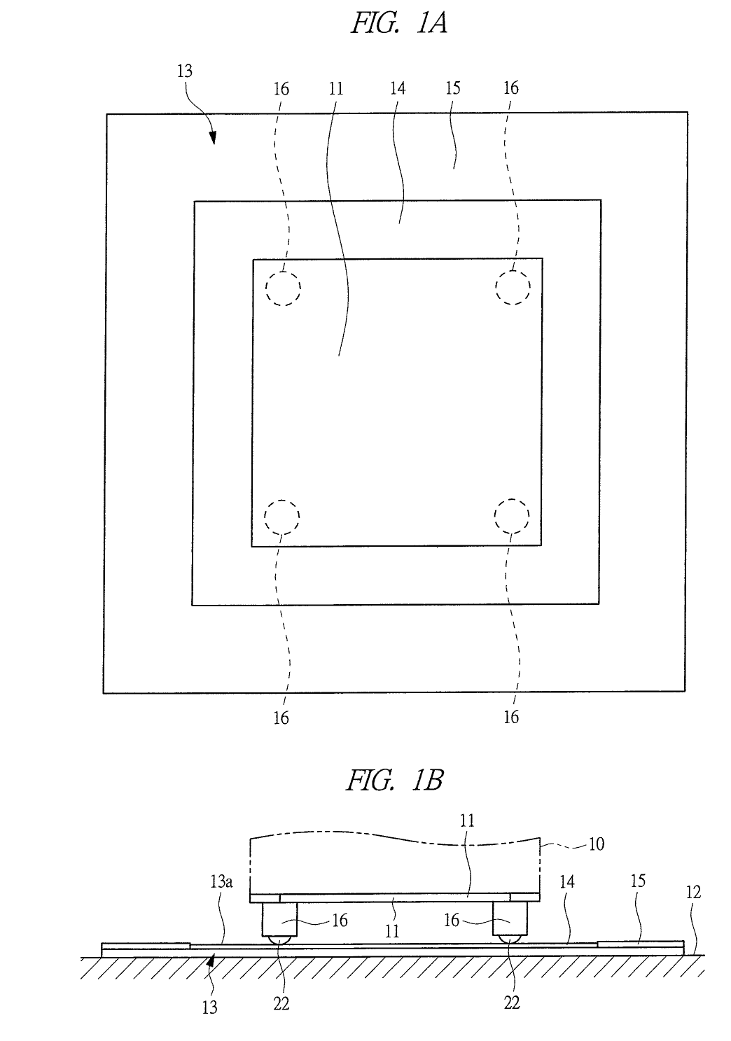

Hereinafter, an embodiment of the present invention will be described in detail with reference to the accompanying drawings. An earthquake-resisting support device for object shown in FIGS. 1A and 1B has a quadrilateral support plate 11 and an object 10 constituted by various apparatuses such as computer or copying machine is disposed on the support plate 11 as shown in a two-dot chain line of FIG. 1B. A quadrilateral base plate 13 is disposed on a floor face of a building on which the object 10 is to be disposed, that is, a base surface 12. A support layer 14 formed of resin such as plastic tile is provided for a central portion of the base plate 13, and a rubber layer 15 thicker than the support layer 14 is provided for an outer peripheral portion of the base plate 13 and each surface of the support layer 14 and the rubber layer 15 serve as a support surface 13a. Holding tables 16 for supporting the object 10 are attached to four corners of the support plate 11, respectively. The number of the holding tables 16 to be attached to the support plate 11 is at least three or an optional number equal to or more than three. Each holding table 16 has a cylindrical outer peripheral surface as shown in a broken line of FIG. 1A.

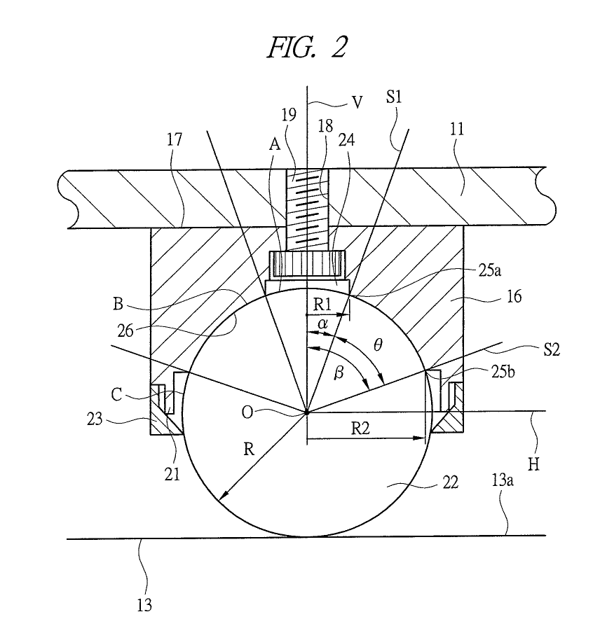

As shown in FIG. 2, each holding table 16 is attached to a lower surface of the support plate 11. A flat load receiving surface 17 receiving a load of an object is formed on an upper surface of the holding table 16, and when the earthquake-resisting support device shown in the drawing is used, the load receiving surface 17 serves as an upper surface. A central portion in a radial direction of an upper end portion of the holding table 16 is formed with a mounting hole 18, and the holding table 16 is attached to the support plate 11 by means of a screw member 19 to be incorporated into the mounting hole 18 and is disposed on the lower side of the object 10.

As shown in FIG. 2, a sphere 22 which is formed of steel, has a radius “R”, and is protruded downward from an opening portion 21 at a lower end of the holding table 16 is attached to the inside of the holding table 16. The sphere 22 is disposed on the base side portion at a lower side of the support plate 11. In order to prevent the sphere 22 from dropping from the holding table 16, a ring-shaped stopper 23 is screwed to the opening portion 21 of the holding table 16.

A concave portion 24 which has a constant radius “R1” from a vertical axis “V” passing through a central point of the sphere 22, that is, a center “O” is formed in the holding table 16 in coaxial relationship with the mounting hole 18, and a surface inside portion “A” of the sphere 22 enters the concave portion 24. The concave portion 24 is partitioned by a ring-shaped small diameter edge 25a formed on the holding table 16, and a portion inside the small diameter edge 25a serves as the concave portion 24. The holding table 16 is formed with a large diameter edge 25b with which a surface center portion “B” and a surface outside portion “C” are partitioned in the sphere 22 and which has a radius “R2”, and a frictional contact surface 26 which is in contact with the surface center portion “B” of the sphere 22 is formed between the small diameter edge 25a and the large diameter edge 25b. The frictional contact surface 26 takes the shape of an internal surface of a sphere having a radius “R” which corresponds to an external surface of the sphere 22, and the surface center portion “B” of the sphere 22 is configured to uniformly come in contact with the whole frictional contact surface 26.

As shown in FIG. 2, if a small diameter edge angle formed by a virtual conical surface “S1” whose apex is located at the center “O” of the sphere 22 and which passes through the small diameter edge 25a and the vertical axis “V” passing through the center “O” of the sphere 22 is represented by “α”, the radius of the concave portion 24, that is, the radius “R1” of the small diameter edge 25a is represented by R·sinα. A portion inside a circle with the radius “R1” forms the concave portion 24 which the surface inside portion “A” of the sphere 22 enters, and the surface inside portion “A” of the sphere 22 does not come in contact with the holding table 16.

In the holding table 16 shown in the drawing, the small diameter edge angle “α” is set to be approximately 20 degrees and the small diameter edge angle “α” is set to be greater than a static friction angle. The static friction angle is an angle at which the holding table 16 does not start to slide with respect to the sphere 22 even if a resultant force “W” of “P” representing a load applied to the holding table 16 by the object 10 and the support plate 11 and “F” representing a force in a direction along the contact surface of the friction contact surface 26 and the sphere 22 is increased at a maximum. The static friction angle is changed depending on a friction coefficient of the friction contact surface 26 and the sphere 22. The static friction angle can be obtained also from a position in which the sphere 22 starts to be rotated by applying a load in a vertical direction to the sphere 22 by means of a needle like member and gradually changing a position in which the load is to be applied from the position of the vertical axis “V” outward in a radial direction.

An angle formed by a virtual conical surface “S2” having an apex located at the center “O” of the sphere 22 and passing through a large diameter edge 25b and the vertical axis “V” passing through the center “O” is represented by a large diameter edge angle “β”, and the radius “R2” of the large diameter edge 25b is represented by R·sinβ. When the large diameter edge 25b is set to be identical to a position of a horizontal surface “H” passing through the center “O” of the sphere 22, the radius “R2” of the large diameter edge 25b is a maximum. The large diameter edge 25b is formed to be on an upper side of the horizontal surface “H” and the large diameter edge angle “β” is set to be approximately 70 degrees in the case shown in the drawing.

Accordingly, in the holding table 16 shown in FIG. 2, a contact angle “θ” of the friction contact surface 26 taking the shape of the inner surface of the sphere with respect to the sphere 22 is 50 degrees. Thus, when the sphere 22 is caused to come in contact with the friction contact surface 26 having a range of a predetermined contact angle “θ”, the friction contact surface 26 comes in contact with the upper part of the sphere 22 in FIG. 2, that is, the surface center portion “B” of the sphere 22 which is an upper side portion higher than the horizontal surface “H”. A tangent of the surface center portion “B” of the sphere 22 and the friction contact surface 26 has an angle with respect to the vertical line “V”. Consequently, when the load of the object 10 is applied to the horizontal load receiving surface 17 of the holding table 16, a load distributed wholly and uniformly from the friction contact surface 26 acts on the sphere 22 toward the center “O”.

Although it is also possible to provide the large diameter edge 25b for the position of the horizontal surface “H”, since the tangent of the friction contact surface 26 in the surface outside portion “C” of the sphere 22 forms an angle which is almost parallel with the vertical axis “V” and a load is rarely applied from the friction contact surface 26 to the sphere 22, the large diameter edge 25b is shifted from the horizontal surface “H” toward the small diameter edge 25a. Even if the large diameter edge angle “β” is set to 45 degrees which is smaller than 70 degrees shown in the drawing, it is found that the distributed load can be applied from the friction contact surface 26 to the sphere 22. When the small diameter edge angle “α” is set to 20 degrees and the large diameter edge angle “β” is set to 45 degrees, the contact angle “θ” is 25 degrees. Thus, the large diameter edge angle “β” can be set within the range from 45 degrees to 90 degrees at a maximum.

In this way, when the friction contact surface 26 taking the shape of the internal surface of the sphere between the small diameter edge 25a and the large diameter edge 25b is caused to come in contact with the sphere 22 within the range of the contact angle “θ”, the load of the object 10 is applied from the whole of the friction contact surface 26 toward the center “O”, and the edge does not enter the sphere 22 but a certain friction force is generated between the sphere 22 and the friction contact surface 26. A material for forming the support surface 13a is set so that a friction coefficient between the sphere 22 and the friction contact surface 26 has a smaller value than a friction coefficient between the sphere 22 and the support surface 13a. For example, the friction coefficient is approximately 0.25 to 0.29 in the case in which the support layer 14 is formed by plastic tile, and is approximately 0.23 to 0.29 in the case in which the support layer 14 is formed by wooden floor. In contrast, when the friction contact surface 26 and the sphere 22 are subjected to mirror finishing and providing a chrome plating coated layer on the friction contact surface 26, the friction coefficient of the friction contact surface 26 is approximately 0.16 to 0.17. On the other hand, when a coated layer formed by fluororesin is provided on the friction contact surface 26, the friction coefficient is approximately 0.11. In any case, the friction coefficient of the friction contact surface 26 is set to have a smaller value than that of the support surface 13a.

By causing the friction contact surface 26 taking the shape of the internal surface of the sphere to come in contact with the sphere 22 and setting a relationship between the friction coefficients of the support surface 13a and the friction contact surface 26, the earthquake-resisting support device shown in the drawing is configured to transmit a horizontal vibration of an earthquake to the object 10 when an acceleration to be applied to the object 10 due to the earthquake is small, and to prevent the horizontal vibration from being transmitted to the object 10 when the acceleration is increased. Consequently, it is possible to prevent the object from falling down at the time of earthquake, and furthermore, to prevent the object from going out of control.

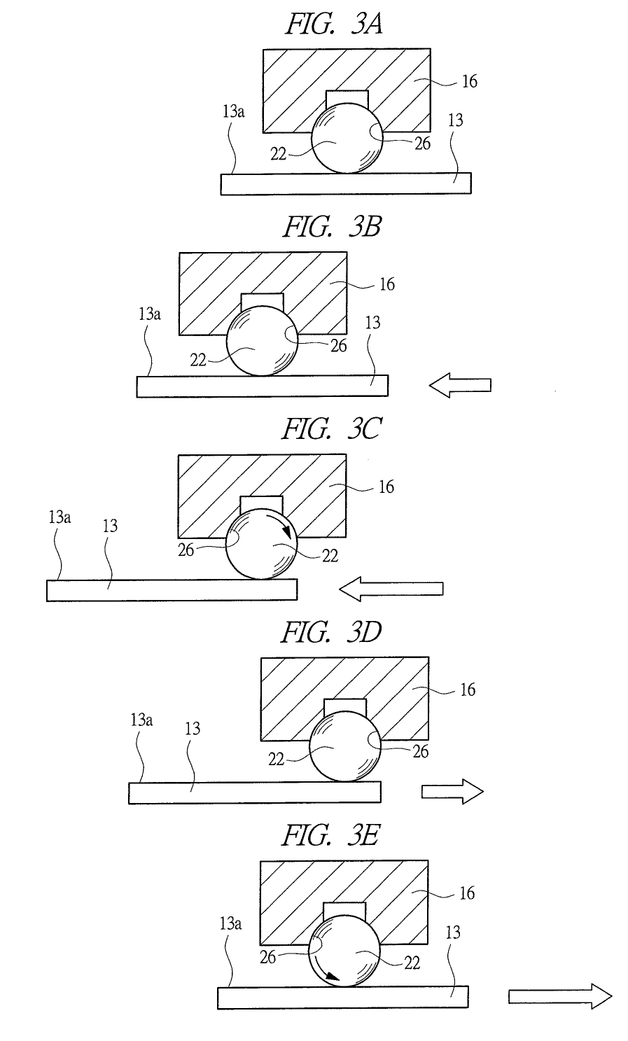

FIGS. 3A to 3E are schematic views each showing an operation to be performed at the time of earthquake by the earthquake-resisting support device shown in FIG. 2.

FIG. 3A shows a state in which the earthquake does not occur. When the earthquake occurs in this state, the base plate 13 is vibrated integrally with the base in a leftward direction in FIG. 3B, and an exciting force is small, as shown in FIG. 3B, the sphere 22 is moved with the base plate 13 by a friction force between the sphere 22 and the support surface 13a and a friction force between the friction contact surface 26 and the sphere 22, and the sphere 22 is not rotated but vibrated integrally with the holding table 16 in a horizontal direction. In other words, the object 10 is vibrated integrally with the base plate 13 under the condition that the exciting force is small.

On the other hand, when the exciting force is increased, as shown in FIG. 3C, since the friction coefficient of the sphere 22 and the friction contact surface 26 is set to be smaller than that of the sphere 22 and the support surface 13a of the base plate 13, the sphere 22 spins under the condition that the sphere 22 is held by the holding table 16 and comes in sliding contact with the friction contact surface 26 while the sphere 22 is rotated and comes in rolling contact with the base plate 13 by the horizontal vibration of the base plate 13. Thus, with increasing the acceleration of the earthquake, the state in which the sphere 22 is horizontally vibrated together with the holding table 16 is changed into the state in which the sphere 22 comes in sliding contact with the friction contact surface 26 while it comes in rolling contact with the base plate 13 on the base side, and at this time, the sphere 22 is rotated with respect to the holding table 16. Consequently, when the acceleration of the earthquake is increased, the acceleration of the earthquake is prevented from being applied to the object 10. If the acceleration to be applied to the object, that is, the response acceleration can be prevented from being increased, the object 10 can be prevented from falling down on the support plate 11.

FIG. 3D shows a state in which the base plate 13 carries out the swing back vibration in the rightward direction from a state in which it carries out the swing back vibration in the leftward direction by the earthquake as shown in FIG. 3C, and when an exciting force is small in an initial stage of the swing back vibration, the sphere 22 is moved with the base plate 13 by the friction force between the sphere 22 and the support surface 13a and the friction force between the friction contact surface 26 and the sphere 22, and the sphere 22 is vibrated integrally with the holding table 16 in a horizontal direction without being rotated.

When the exciting force is increased, as shown in FIG. 3E, since the friction coefficient of the sphere 22 and the friction contact surface 26 is set to be smaller than that of the sphere 22 and the support surface 13a of the base plate 13, the sphere 22 spins under the condition that it is held by the holding table 16 and comes in sliding contact with the friction contact surface 26 while it is rotated with respect to the base plate 13 by the horizontal vibration of the base plate 13 and comes in rolling contact with the base plate 13.

If a great exciting force is applied when the base plate 13 carries out the swing back vibration in the rightward direction from the state shown in FIG. 3C, the sphere 22 is not vibrated integrally with the holding table 16 in the horizontal direction as shown in FIG. 3D but spins under the condition that it is held by the holding table 16 as shown in FIG. 3E. In other words, a state in which the sphere 22 spins in a direction shown in FIG. 3C is changed into a state in which the sphere 22 spins in a direction shown in FIG. 3E.

Thus, when the exciting force caused by the earthquake is small, the holding table 16 is vibrated integrally with the sphere 22 by the friction force between the sphere 22 and the friction contact surface 26. When the exciting force is increased, a state in which the sphere 22 is in static friction contact with the friction contact surface 26 is changed into a state in which the sphere 22 is in rolling friction contact with the friction contact surface 26 so that the sphere 22 spins, and the vibration is prevented from being transmitted from the base surface 12 side to the object 10. Consequently, even if an earthquake having a great seismic intensity occurs, the object 10 attached onto the support plate 11 can be prevented from falling down or going out of control.

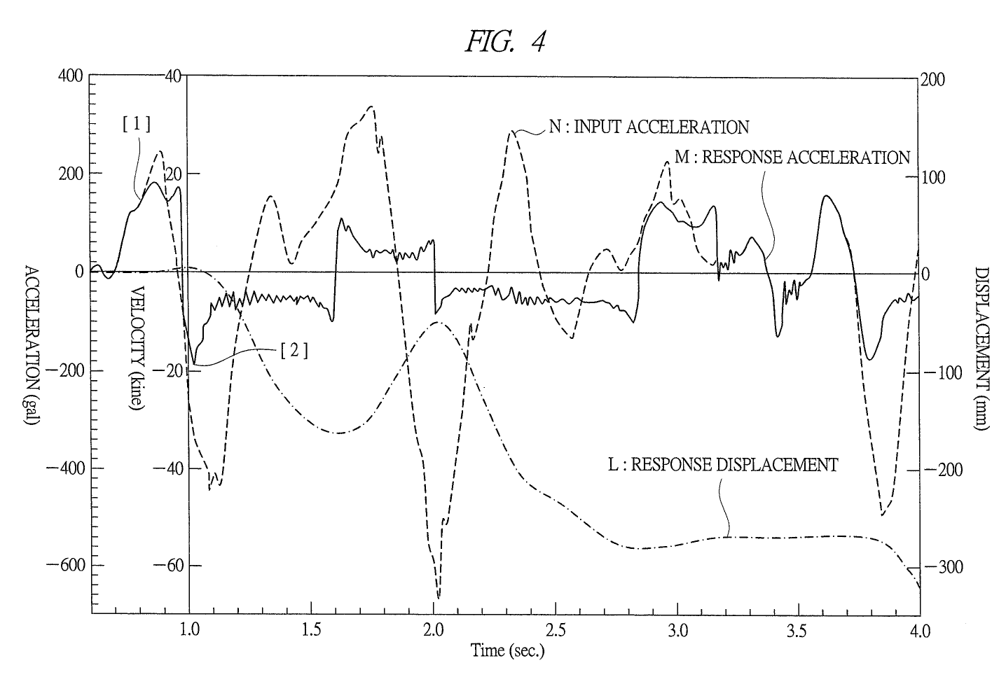

FIG. 4 is an earthquake-resisting characteristic diagram at the time of earthquake in the earthquake-resisting support device shown in FIG. 2. The earthquake-resisting characteristic diagram shows a relationship between an input acceleration “N” to be applied to the base surface and a response acceleration “M” and a response displacement “L” in the support plate 11 in the case in which the base surface supporting the base plate 13 is vibrated by an exciting device. In an initial stage of the occurrence of the vibration, the response acceleration “M” closely similar to the input acceleration “N” is applied to the support plate 11. When it exceeds 180 gal, since the sphere 22 spins and comes in rolling contact with the friction contact surface 26, the great input acceleration “N” is not transmitted to the support plate 11. Similarly, even if the input acceleration is applied in a swing back direction, the sphere 22 spins and the great input acceleration “N” is not transmitted to the support plate 11 when it exceeds 180 gal.

For example, if the input acceleration exceeds 180 gal at approximately 0.5 second after the base surface is vibrated, the sphere 22 spins, so that the response acceleration “M” is prevented from being raised as shown in [1]. Even if the swing back vibration is applied after 0.7 second, the sphere 22 spins in a reverse direction because the acceleration is great at this time, and a response acceleration of 180 gal or more in a reverse direction or a negative direction is prevented from being applied to the support plate 11 as shown in [2]. When the input acceleration is equal to or smaller than 180 gal, the sphere 22 and the holding table 16 are vibrated integrally with the base plate 13, and the support plate 11 is displaced as shown in FIG. 4.

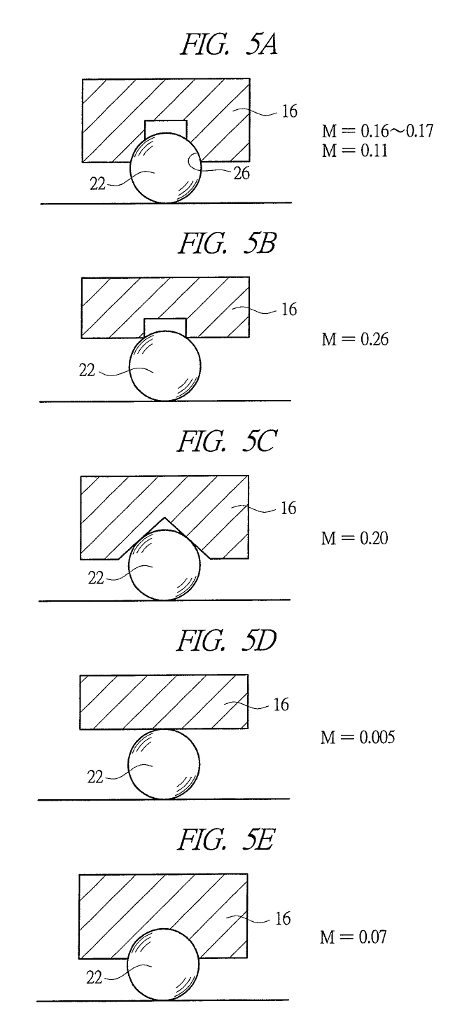

FIGS. 5A to 5E are comparison views each showing a friction coefficient of a contact portion of the sphere and the holding table obtained by changing the shape of the holding table 16 in the earthquake-resisting support device using the sphere 22. Each friction coefficient is measured under the condition that a certain load is applied to the holding table 16.

FIG. 5A shows the earthquake-resisting support device according to the present invention, when each of the friction contact surface 26 and the surface of the sphere 22 is subjected to mirror finishing and a chromium plating coated layer is provided on the friction contact surface 26, the friction coefficient “μ” is approximately 0.16 to 0.17 as described above. On the other hand, when a coated layer made of fluororesin is provided on the friction contact surface 26, the friction coefficient “μ” is approximately 0.11.

In contrast, FIG. 5B shows the case in which the sphere 22 is caused to come in contact with a circular edge formed on the holding table 16 so as to correspond to the earthquake-resisting support device described in Patent Document 2, and FIG. 5C shows the case in which the sphere is caused to come in contact with a cone-shaped holding surface formed on the holding table 16 so as to correspond to the earthquake-resisting support device described in Patent Document 3. Referring to the sphere 22 and the holding table 16 of each case, the circular edge comes in line contact with the sphere 22 in the case shown in FIG. 5B, and a part of the cone-shaped holding surface comes in line contact with the sphere 22 in the case shown in FIG. 5C. The respective friction coefficients “μ” are 0.26 and 0.20.

On the other hand, as shown in FIG. 5D, in the case in which the contact surface of the holding table 16 is flat, the friction coefficient “μ” is 0.005. Furthermore, in the case in which a hemispherical surface in the upper half of the sphere 22 including a top portion of the sphere 22 is caused to come in contact with the holding table 16 as shown in FIG. 5E, the friction coefficient “μ” is 0.07. As shown in FIG. 5D, in the earthquake-resisting support device in which the contact surface of the holding table 16 is flat, when the base surface is horizontally moved by the earthquake, since the sphere 22 is rolled along the lower surface of the holding table 16 even if the input acceleration is small, the response acceleration is reduced. In other words, it is possible to prevent the earthquake from being transmitted to the object when the input acceleration is small. However, the object put on the holding table 16 goes out of control.

Moreover, as shown in FIG. 5E, even if the input acceleration is small, the sphere 22 is rolled along the lower surface of the holding table 16 also in the earthquake-resisting support device in which the contact surface is hemispherical. Consequently, the object put on the holding table 16 goes out of control. This is probably because a load concentrates on the top portion and almost the same behavior as that in the case in which the contact surface is flattened as shown in FIG. 5D is substantially taken if the friction contact surface is caused to come in contact with the top of the sphere 22, that is, a surface inside portion as shown in FIG. 5E. In other words, when static friction coefficients are measured in a state in which a predetermined load is applied, it is found that the static friction coefficients are greatly different from each other even if a surface roughness is similarly set in both the case in which the friction contact surface 26 is formed as shown in FIG. 5A and the case in which the upper half of the sphere 22 is caused to almost come in contact with the internal surface of the sphere of the holding table 16 as shown in FIG. 5E.

In the present invention shown in FIG. 5A, when the friction contact surface 26 formed between the small diameter edge 25a and the large diameter edge 25b is caused to come in contact with the sphere 22, the friction coefficient is small as compared with the cases shown in FIGS. 5B and 5C. This is probably because a load is wholly distributed from the friction contact surface 26 and is thus applied to the sphere 22 and the sphere 22 and the friction contact surface 26 come in face contact with each other. In the case in which the holding table 16 is caused to come in contact with the sphere 22 as shown in FIGS. 5D and 5E, since the holding table 16 substantially comes in line contact or point contact with the sphere 22, the sphere 22 is rotated with respect to the holding table 16 in a stage in which the input acceleration is small. Consequently, it is impossible to prevent the object from going out of control.

In contrast, in the earthquake-resisting support device according to the present invention, the sphere 22 is caused to come in contact with the friction contact surface 26 between the small diameter edge 25a and the large diameter edge 25b in the holding table 16. Therefore, when the exciting force is increased so that the rotating force to be applied from the sphere 22 to the friction contact surface 26 is increased, the sphere 22 is caused to come in sliding contact with the friction contact surface 26 and to spin. In this manner, it is possible to perform an earthquake-resisting support for the object, that is, a seismically-isolating support for the object. In addition, the friction contact surface 26 does not bite into the sphere 22 but can maintain a certain static friction coefficient for a long period of time.

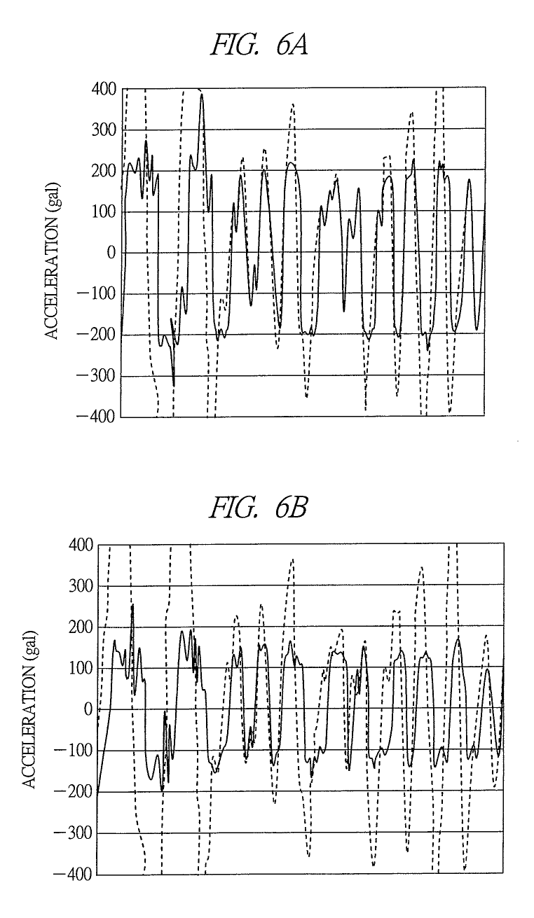

FIGS. 6A and 6B are earthquake-resisting characteristic diagrams each indicative of a result obtained by measuring a comparison between the input acceleration and the response acceleration by changing the friction coefficient of the friction contact surface 26 in the earthquake-resisting support device according to the present invention. FIG. 6A shows a comparison between the input acceleration and the response acceleration in the case in which the friction contact surface 26 is subjected to chromium plating treatment to set the friction coefficient to be approximately 0.16 to 0.17, and FIG. 6B shows a comparison between the input acceleration and the response acceleration in the case in which fluororesin is applied to the friction contact surface 26 to set the friction coefficient “μ” to be approximately 0.11. In the measurement, the sphere 22 having a diameter of 1 inch (2.54 cm) is utilized and a weight of 20 Kg is used as the object 10. As shown in FIG. 6A, in the case in which the friction contact surface 26 is subjected to chromium plating treatment, when the input acceleration exceeds 200 gal, the sphere 22 spins and the vibration is not transmitted to the object any longer. On the other hand, in the case in which fluororesin is applied to the friction contact surface 26, when the input acceleration exceeds 120 to 150 gal, the sphere 22 spins and the vibration is not transmitted to the object any longer.

The present invention is not restricted to the embodiment but various changes can be made without departing from the gist thereof. Although the sphere 22 is attached to the lower side of the holding table 16 in the earthquake-resisting support device which is shown in the drawing, for example, the relationship between the holding table 16 and the sphere 22 may be vertically reversed and they may be disposed between the object 10 and the base surface 12. In that case, the lower surface of the support plate 11 to which the object is to be attached is set to be the support surface 13a and the sphere 22 is caused to come in contact with the support surface 13a. Thus, the holding table 16 is fixed to the base surface 12. Although an apparatus to be disposed in a building is subjected to an earthquake-resisting support in the earthquake-resisting support device shown in the drawing, moreover, it is also possible to carry out the earth-resisting support over a building structure itself.

What is claimed is:

1. An earthquake-resisting support device for object which stably supports an object disposed on a base at the time of earthquake, the earthquake-resisting support device for object comprising:
a metallic holding table attached to one of the object and the base; and
a sphere formed of steel, and attached into the holding table and protruded from an opening surface of the holding table to come in contact with a support surface provided to the other of the object and the base,
wherein a friction contact surface taking a shape of an internal surface of a sphere which comes in contact with the sphere is formed in the holding table between a circular small diameter edge and a circular large diameter edge, the circular small diameter edge having a certain radius from a vertical line passing through a center of the sphere and serving to define a concave portion which a surface inside portion of the sphere enters, and the circular large diameter edge setting, as a maximum radius, a radius along a horizontal surface passing through a center of the sphere,
a static friction coefficient of the friction contact surface and the sphere is set to be smaller than a static friction coefficient of the sphere and the support surface, and
with increasing an acceleration of the earthquake, a state in which the sphere is horizontally moved integrally with the holding table is changed into a state in which the sphere comes in sliding contact with the friction contact surface to spin in the holding table, thereby suppressing a transmission of a vibration to the object from the base.

2. The earthquake-resisting support device for object according to claim 1, wherein a small diameter edge angle formed by a virtual conical surface having an apex located at a center of the sphere and passing through the small diameter edge is greater than a static friction angle of the sphere and the holding table.

3. The earthquake-resisting support device for object according to claim 1, wherein a large diameter edge angle formed by a virtual conical surface having an apex located at a center of the sphere and passing through the large diameter edge and a vertical axis passing through the center of the sphere is within a range from 90 degrees to 45 degrees.

4. The earthquake-resisting support device for object according to claim 1, wherein a chromium plating coated layer is provided on the friction contact surface and a friction coefficient “μ” between the friction contact surface and the sphere is set to be approximately 0.16 to 0.17.

5. The earthquake-resisting support device for object according to claim 1, wherein a coated layer formed of a fluororesin is provided on the friction contact surface and a friction coefficient “μ” between the friction contact surface and the sphere is set to be approximately 0.11.

6. The earthquake-resisting support device for object according to claim 1, wherein at least three holding tables are attached to a support plate for supporting the object, and spheres attached to the respective holding tables are disposed on a support surface of a base plate provided on the base.
